(19) United States
(12) Patent Application Publication
(10) Pub. No.: US 2026/0299205 A1
(43) Pub. Date: Oct. 1, 2026

(54) TUNABLE OPTICAL FADING IN A RECEIVER TO IMPROVE OUT OF BAND REJECTION FOR VARIABLE BAUD

(71) Applicant: CIENA CORPORATION, Hanover, MD (US)

(72) Inventors: Michael Vitic, Chelsea (CA); Ian Betty, Ottawa (CA); Scott Kuntze, Ottawa (CA); Antoine Bois, Quebec (CA)

(73) Assignee: CIENA CORPORATION, Hanover, MD (US)

(21) Appl. No.: 19/095,972

(22) Filed: Mar. 31, 2025

(51) Int. Cl. G02B 6/28; G02F 1/21; H04B 10/61

(52) U.S. Cl. CPC G02B 6/2861; G02F 1/212; H04B 10/61

(57) ABSTRACT

Aspects of the subject disclosure may include, for example, receiving an optical signal; splitting the optical signal into multiple paths including a direct path, a first delay path, and a second delay path, where the splitting includes directing a first portion of the optical signal through the direct path to a photodetector, where the splitting includes selectively directing a second portion of the optical signal through the first and second delay paths of different lengths to introduce selectable and variable optical delays; directing the second portion of the optical signal from the first and second delay paths to the photodetector; and generating a photocurrent from the first portion and second portion of the optical signal at the photodetector. Other embodiments are disclosed.

### FIELD OF THE DISCLOSURE

The subject disclosure relates to tunable optical fading in a receiver to improve out of band rejection for variable baud.

### BACKGROUND

In the realm of high-speed optical communication systems, the demand for increased data transmission rates has led to the development of advanced receivers capable of handling higher baud rates. These systems often face challenges related to bandwidth limitations and signal interference, particularly when attempting to maintain performance across varying baud rates. Traditional receivers struggle to effectively filter out unwanted signal(s) noise from adjacent channels, which can degrade signal quality and reduce the overall efficiency of data transmission. These adjacent channels or aggressor signals may make their way through a photodetector and load an input of a Transimpedance Amplifier (TIA) with extra unwanted photocurrent. In these situations, adjacent means other modulated signals adjacent in frequency (or spectrum). This issue is exacerbated in systems seeking compatibility with multiple operating modes, such as those transitioning between different baud rates.

Existing solutions typically rely on fixed bandwidth optical filtering methods, which lack the flexibility needed to adapt to dynamic signal conditions. The ability for narrow bandwidth, bandwidth turnability, wavelength tuning and low loss all at the same time are difficult to achieve. These methods often result in suboptimal signal-to-noise ratios (SNR) and increased susceptibility to interference, particularly in environments with high channel density. Current technologies do not adequately address the challenges of maintaining high performance and signal integrity across diverse operating conditions.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a circuit in accordance with various aspects described herein.

FIGS. 2A-2D are block diagrams illustrating exemplary, non-limiting embodiments of relative power results in accordance with various aspects described herein.

FIG. 3 is a block diagram illustrating an exemplary, non-limiting embodiment of a circuit in accordance with various aspects described herein.

FIGS. 4A-4D are block diagrams illustrating exemplary, non-limiting embodiments of relative power results in accordance with various aspects described herein.

FIGS. 5A-5B are block diagrams illustrating exemplary, non-limiting embodiments of relative power results in accordance with various aspects described herein.

FIG. 6 depicts an illustrative embodiment of a method 600 in accordance with various aspects described herein.

FIG. 7 is a block diagram illustrating an exemplary, non-limiting embodiment of a circuit in accordance with various aspects described herein.

FIGS. 8A-8B are block diagrams illustrating exemplary, non-limiting embodiments of circuits in accordance with various aspects described herein.

FIG. 9 is a block diagram illustrating an exemplary, non-limiting embodiment of a device or circuit in accordance with various aspects described herein.

FIG. 10 is a block diagram illustrating an exemplary, non-limiting embodiment of a device or circuit in accordance with various aspects described herein.

FIGS. 11A-11F are block diagrams illustrating exemplary, non-limiting embodiments of circuits in accordance with various aspects described herein.

FIG. 12 is a block diagram of an example, non-limiting embodiment of a computing environment in accordance with various aspects described herein.

### DETAILED DESCRIPTION

The subject disclosure describes, among other things, illustrative embodiments for providing selectable. tunable and/or variable optical fading, which can be achieved such as through use of a Mach Zehnder Interferometer(s) (MZIs) and at least two additional delay paths, where dual entry, quad entry, or multiple HSPDs receive the total light to reduce peak intensity to mitigate charge screening effects.

As an example, the MZI can steer light through either a ‘short’ delay path, a second ‘longer’ delay path or splits the light between the two. In other embodiments, other numbers and other configurations of delay paths can be utilized. Various lengths of delay paths and their differentials can be utilized according to various factors including the operating mode(s) of the receiver. In one embodiment, a dual band power detector in a Digital Signal Processor (DSP) can measure both lower-band and full-band channel powers. For example, in-band power can be maximized while minimizing out-of-band power until an optimum or improved SNR is achieved. It should be understood that maximizing and minimizing as described herein can include increasing in-band power and/or decreasing out-of-band power with respect to a threshold, such as above a threshold or within a threshold. For example, maximize can include a process of increasing a particular parameter or signal strength to reach or exceed a predefined threshold, such as to a level that meets or surpasses a desired performance criteria. Conversely, minimizing can include reducing a parameter or signal strength to fall below a specified threshold, such as not exceeding a level that would degrade system performance. For instance, the thresholds can serve as a limit, guiding adjustments to maintain signal integrity and reduce noise or interference. Other embodiments are described in the subject disclosure.

One or more aspects of the subject disclosure can include a method comprising receiving an optical signal; and splitting the optical signal into multiple paths including a direct path, a first delay path, and a second delay path. The splitting can include directing a first portion of the optical signal through the direct path to a photodetector, where the splitting includes selectively directing a second portion of the optical signal through the first and second delay paths of different lengths to introduce selectable and variable optical delays. The method can include directing the second portion of the optical signal from the first and second delay paths to the photodetector; and generating a photocurrent from the first portion and second portion of the optical signal at the photodetector.

One or more aspects of the subject disclosure can include a circuit comprising a 90° hybrid mixer configured to receive a local oscillator (LO) signal and an optical signal, where the 90° hybrid mixer splits the incoming optical signal into in-phase (I) and quadrature (Q) components. The circuit can include, for each output of the 90° hybrid mixer: a splitter coupled to the output of the 90° hybrid mixer, where the splitter is configured to steer a portion of light from the output of the 90° hybrid mixer between a plurality of delay paths of different lengths to create a selectable and variable optical fading effect; and a photodetector configured to generate an electric photocurrent influenced by the optical fading effect.

One or more aspects of the subject disclosure can include a method performed in a coherent modem, where the method comprises determining an operating mode of the coherent modem. The method can include receiving an optical signal at an Intradyne Coherent Receiver (ICR); splitting the optical signal into a plurality of components including in-phase (I) and quadrature (Q) components; and performing tunable optical fading on the plurality of components of the optical signal based on the operating mode. The method can include generating an electrical photocurrent influenced by the tunable optical fading at a photodiode; and converting the electrical photocurrent to an electrical voltage signal at a transimpedance amplifier (TIA).

One or more aspects of the subject disclosure can include a method comprising receiving an optical signal at an Intradyne Coherent Receiver (ICR). The method can include splitting the optical signal into multiple paths including a direct path, a first delay path, and a second delay path, where the splitting includes directing a first portion of the optical signal through the direct path to a photodetector such as a High-Speed Photodetector (HSPD), where the splitting includes directing a second portion of the optical signal through the first and second delay paths of different lengths to introduce selectable and variable optical delays. The method can include combining delayed optical signals from the first and second delay paths at the HSPD to produce a photocurrent including based on the first portion of the optical signal. The method can further include processing the photocurrent with a transimpedance amplifier (TIA) to convert the photocurrent into an electrical signal.

One or more aspects of the subject disclosure include a circuit, comprising a 90° hybrid mixer configured to receive a local oscillator (LO) signal and an optical signal, where the 90° hybrid mixer is splitting the incoming optical signal into in-phase (I) and quadrature (Q) components. The circuit can include optical splitters or combiners such as a plurality of Multi-Mode Interferometers (MMIs), which can be a 2×2 MMI or other configuration of an MMI) coupled to outputs of the 90° hybrid mixer, where each MMI is configured to split the light into two distinct paths. In other embodiments, the splitting can be done using couplers, directional couplers, y-branches, or by any components and/or functionality that splits an optical signal, including components or functionality that splits the optical signal in half. In other embodiments, the splitting can be in other ratios, which can include other configurations of components, such as 60:40 or 70:30 splitting.

The circuit can include a plurality of phase shifters, such as Thermal Phase Shifters (TPSs), associated with the MMIs, where the TPSs are configured to control the phase of the light in one of the paths, enabling selectable and variable optical fading. In other embodiments, other types of phase shifters can be utilized including carrier injection, Electro-Optic (EO) and so forth. The circuit can include a plurality of delay paths of different lengths configured to create an optical fading effect; a High-Speed Photodetector (HSPD) configured to combine the delayed optical signals and generate a photocurrent influenced by the optical fading effect; and a transimpedance amplifier (TIA) coupled to the HSPD, where the TIA is configured to convert the photocurrent into an electrical signal. In one embodiment, three photodetectors can be used to measure three paths, without the need to combine any of the signals.

One or more aspects of the subject disclosure include a device comprising: a controller that determines Lower Band (LB) and Broad Band (BB) power, determines an operating mode, and according to the operating mode either maximizes the BB power for full-Baud mode or minimizes the difference between BB and LB powers while maximizing LB-Power for half-baud mode (which can include rejecting the signal outside the LB, by minimizing the summary BB−LB signal). The device can include a circuit coupled to the controller for performing optical fading, where the circuit comprises a 90° hybrid mixer configured to receive a local oscillator (LO) signal and an optical signal, and where the 90° hybrid mixer is splitting the optical signal into in-phase (I) and quadrature (Q) components. The circuit can include splitters (e.g., a plurality of 2×2 Multi-Mode Interferometers (MMIs)) coupled to the outputs of the 90° hybrid mixer, where each of the splitters is configured to split the light into two distinct paths. The circuit can include a plurality of phase shifters (e.g., Thermal Phase Shifters (TPSs)) associated with the splitters or MMIs, where the phase shifters or TPSs are configured to control the phase of the light in one of the paths, enabling selectable and variable optical fading; a plurality of delay paths of different lengths configured to create an optical fading effect; a High-Speed Photodetector (HSPD) configured to combine the delayed optical signals and generate a photocurrent influenced by the optical fading effect; and a transimpedance amplifier (TIA) coupled to the HSPD, where the TIA is configured to convert the photocurrent into an electrical signal.

An increase in baud rate can result in an increase in bandwidth of a receiver due to the fundamental relationship between baud rate and bandwidth in communication systems. Baud rate refers to the number of signal changes or symbols transmitted per second in a communication channel, which is a measure of how quickly data is being sent over a communication medium. The bandwidth of a communication system is the range of frequencies that the system can effectively transmit or receive, which can be directly related to the baud rate because each symbol or signal change requires a certain amount of frequency spectrum to be accurately transmitted and received.

As baud rate increases, more symbols are transmitted per second. This may require a wider frequency range to accommodate the increased number of signal changes. Higher baud rates mean that the system must handle more data transitions in the same amount of time, which necessitates a broader bandwidth to ensure that these transitions are captured accurately without distortion. A wider bandwidth allows the receiver to capture more of the signal's frequency components, which can be important for maintaining signal integrity and minimizing errors. It also can facilitate in distinguishing the desired signal from noise and interference, which is particularly important in high-speed communication systems.

As an example in an Intradyne Coherent Receiver (ICR), the receiver's components, such as the transimpedance amplifier (TIA) and analog-to-digital converter (ADC), can be designed to handle the increased bandwidth requirements associated with higher baud rates. This ensures that the receiver can process the incoming signals effectively, maintaining high performance and signal quality. As the baud rate increases, the receiver can have a corresponding increase in bandwidth to accommodate the higher data transmission rate, ensuring accurate signal processing and maintaining communication quality.

Optical fading can be used to manage and control the intensity of light signals, which can be particularly important in systems like an ICR, which is used to receive and process optical signals in high-speed data communication networks. In optical communication, light signals carry data over long distances. However, there is a desire to reject the adjacent signal, which are effectively noise on top of the central signal and which can interfere with the desired signal and degrade the quality of the data being received. One or more of the exemplary embodiments can apply selectable, variable and/or tunable fading to compensate or otherwise account for noise.

Optical fading can function as a filter that selectively reduces the intensity of certain parts of the light signal. By doing this, one or more of the exemplary embodiments can minimize or reduce interference from unwanted noise or signals from adjacent channels. In one or more embodiments, the system uses components, such as splitters (e.g., MMIs) and MZIs, to divide the light into various paths. These paths can have different delays, meaning the light takes longer to travel through one path compared to another. By selectively controlling these delays and how the light is recombined, the system can produce a fading effect that reduces the power of unwanted signals. For instance, this technique can help improve the SNR, which is a measure of signal quality. By reducing the noise, the system can more accurately detect and process the desired data, leading to better performance in high-speed communication systems. Optical fading can be a method used to enhance the quality of optical signals by reducing interference from unwanted noise, thereby improving the overall performance of optical communication systems.

One or more of the exemplary embodiments, provide selectable, tunable and/or variable optical fading, such as within an ICR, to enhance out-of-band rejection for variable baud rates. This can be done through an optical filtering mechanism that combines optical and electrical domains. As an example, the filtering mechanism can utilize one or more MMI-based splitters (e.g., 2×2) and MZIs with TPSs. The system allows for selectable, tunable, and/or variable fading by steering light through different optical delay paths, such as for compatibility with multiple operating models including 400ZR and 800ZR modes. This approach not only optimizes SNR by minimizing adjacent channel interference but also addresses the challenge of maintaining high performance across varying baud rates without compromising the receiver's bandwidth. The ability to dynamically adjust optical paths and delay configurations can provide a benefit over traditional fixed optical filtering methods, providing enhanced flexibility and efficiency, such as in coherent optical communication systems.

In one or more embodiments, the components and/or techniques described herein can have an application to any devices, systems or functionality that applies coherent detection. Optical fading offers a large benefit to ICRs due to its nature in being coherent (e.g., having an LO to select the wavelength), and fading to help in rejecting adjacent channels in colorless applications.

In one or more embodiments, an advantage of using optical fading in various optical devices is the improvement in SNR, which enhances the quality of the received signal. This can lead to better performance in any optical system where signal clarity is important.

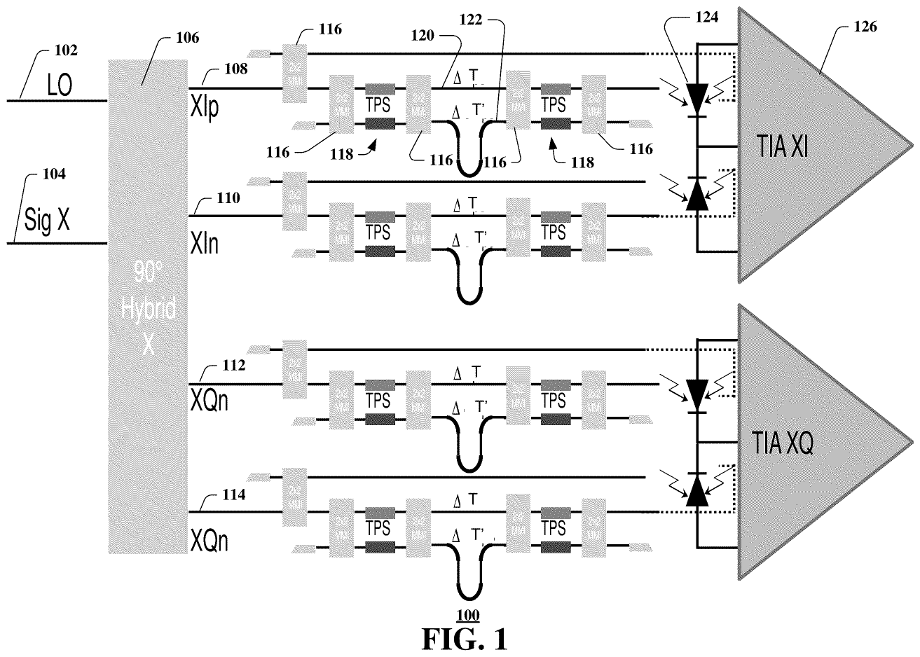

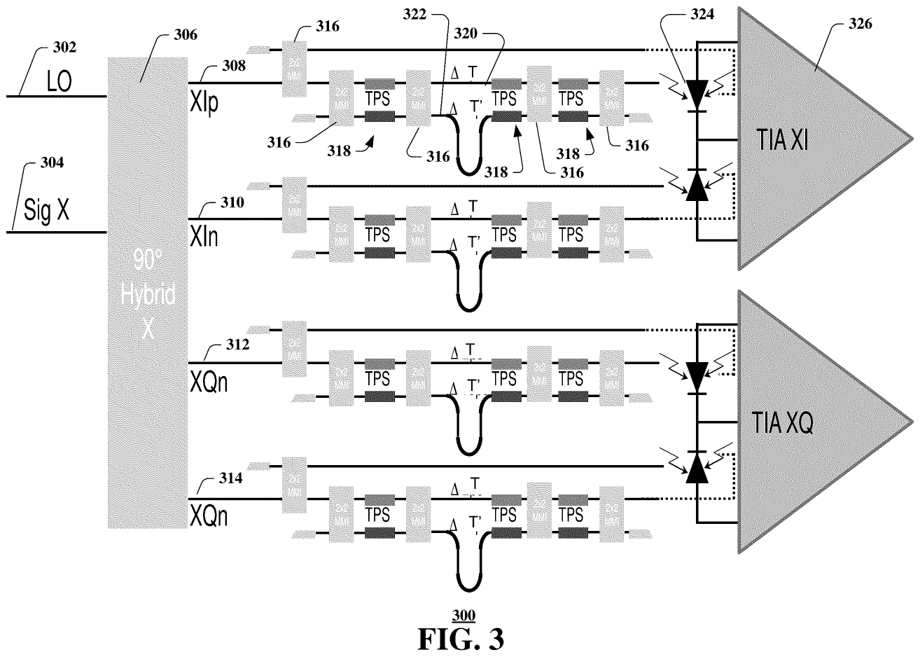

FIG. 1 is a block diagram illustrating an exemplary, non-limiting embodiment of a circuit 100 in accordance with various aspects described herein, which can be single polarization in an ICR with selectable fading. One or more of the exemplary embodiments provides backwards compatibility. For next generation coherent optical modems such as for datacenter applications (e.g., 800ZR, 1600ZR, 3200ZR, and future or next generation devices or functionality), there can be a benefit for modems to have backwards compatibility to the previous generation of modems (e.g., 400ZR, 800ZR and 1600ZR respectively (Half Baud)). By providing backwards compatibility, the system and techniques described herein (e.g., which utilize circuit 100 or circuit 300 described with respect to FIG. 3) can enable network operators to upgrade a head end while a far end is still using the previous generation device(s), maximizing their fiber utilization between datacenters.

The system and methodology described herein addresses the scenario where as baud increases so does bandwidth of each one of the components, thus making a bandwidth selectable TIA to enable half-baud backwards compatibility possible without compromising the performance at full-baud. One or more of the exemplary embodiments address the situation that as a result at half-baud, a TIA's full bandwidth (e.g., 60 GHz) may not only pick up the desired channel but also the neighboring channel in a colorless system, increasing the thermal noise of the TIA and generating mixing products within the desired bandwidth (e.g., 30 GHz), degrading the SNR.

One or more of the exemplary embodiments (including one or more components and/or functions described herein) can be utilized with one or more components and/or functions described in U.S. Pat. No. 10,830,638, such as a photodetector with improved saturation current and fixed optical filtering. For example, optical fading can either be made selectable or tunable or otherwise variable with the use of multiple delay interferometers.

In one or more embodiments, the methodology takes advantage of optical waveguides having different lengths from the optical splitting element up to the photodiode, such that the individual contributions from the two optical paths will be delayed in time. As a result, low frequency components from two or more optical inputs will sum properly in phase, while high frequency components will sum only partially due to the phase difference in the delayed signals. Some RF fading of the high frequency components in the modulated signal thus occurs. At some specific frequency, the two contributions can even be totally out of phase and cancel each other in the output photocurrent generated by the photodetector. By selecting multiple paths to the photodiode and uneven optical power partitioning between these different selected paths, it allows for a tuned shaping of the photodetector response. The output current from the photodiode is the sum of all contributions produced by the delayed optical signals:

$$i {out}_{} ( t ) = {\sum }_{k = 1}^{n} {A}_{k} i ( t + Δ {t}_{k} )$$

where n is the number of paths going from the splitting element to the photodiode, Aₖ is the fraction of optical power going into path k and Δtₖ its optical delay. In this more general case, the power spectral density of the modulation signal at the photodiode output will thus be given by:

$${S}_{i , out} ( f ) = {S}_{mod} ( f ) {\vert {\sum }_{k = 1}^{n} {A}_{k} {e}^{i 2 π f Δ {t}_{k}} \vert}^{2}$$

As an example, circuit 100 can provide backwards compatibility via a selectable fading tuner, which in some embodiments can build on a fading function after the hybrid mixer. For instance, a 2×2 MMI based 50/50 splitter (or other splitter device or functionality) can be utilized to split the light (e.g., equally) between one direct path to one side of a dual-entry HSPD and a second path to a 2×2 MMI MZM with a phase shift controller (e.g., a TPS phase controller), followed by mismatched optical paths and also followed by a second 2×2 MMI MZM to steer all the light into the other side of the dual-entry HSPD.

Thermal phase shifters can be used to switch light between the ΔT (e.g., a short path) and ΔT′ (e.g., a long path) paths, based off the Rx operating mode: for example for a high baud mode (e.g., 800ZR) all the light is steered in the ΔT, while in a low baud mode (e.g., 400ZR) all the light is tuned to the ΔT″ path. The particular baud modes can vary and can generally be described as Baud and Baud/2, which can include the 800ZR and 400ZR, as well as other baud modes. In one or more embodiments, the short path can be on an order of magnitude of around 1 ps or between 0.05 and 10 ps, while the long path can be on an order of magnitude of around 10 ps or between 0.5 ps and 100 ps. However, other lengths of delay paths including the short and long paths can also be utilized which may be within or outside of the ranges or orders of magnitude described above. It should be understood that delays may depend on baud and/or amount of rejection and can result in the use of other ranges such as a short path of 0.05 ps to 0.5 ps (e.g., 0.1 ps) and a long path of 0.5 ps to 5 ps (e.g., 1 ps). As other examples, 1.5-2.0 ps on a first delay path and 8-10 ps on a second delay path can be utilized; 0.75 ps on a first delay path and 2-4 ps on a second delay path can be utilized; or 0.2-0.4 ps on a first delay path and 1-2 ps on a second delay path can be utilized.

If necessary, the reference path sent to the other entry port of the photodiode with no tuning may be matched in waveguide dispersion to support the band of interest. This may include changing the waveguide type, width, and/or any relevant property to match components realizing the tuning in the other path, such as MMI couplers and TPS. For example, a 1-to-1 MMI may match the 2×2 MMI in dispersion characteristics.

In one or more embodiments, a Digital Signal Processor (DSP) can have Broad-Band (BB) and Lower Band (LB) power detectors, such as covering 0 to FS/2 and lower from 0 to FS/4, where the upper band power is the difference between BB and LB.

In 400ZR mode, the modem's digital power detectors can be used to control the TPS to maximize or improve the signal in the lower band and minimize the power in the upper band. In 800ZR mode, the modem's digital power detector can be used to control the TPS to maximize or improve the signal throughout the whole band.

In FIG. 1, the processing of the “Sig X” component within the circuit 100 of an Intradyne Coherent Receiver (ICR) is depicted. The incoming optical signal “Sig X” 104 is combined with the Local Oscillator (LO) signal 102 in a 90° hybrid mixer 106, which is responsible for splitting the signal into in-phase (I) and quadrature (Q) components. These components are labeled as XIp 108, XIn 110, XQn 112, and XQn 114. Each of these outputs can then be fed into 2×2 MMIs 116, which split the light into distinct paths (e.g., two). This splitting is important for the subsequent optical processing steps.

The circuit 100 can employ TPSs 118 to control the phase of the light in one of the paths. By adjusting the phase, the circuit 100 can steer the light through different delay paths, enabling selectable and variable optical fading. For example, the light can be directed through delay paths of different lengths, such as a 2 picoseconds path 120 and an 8.2 picoseconds path 122. These delays are used to create a fading effect that helps filter out unwanted signals and improve the SNR. Other lengths of paths and thus other delays in picoseconds can be utilized depending on a number of factors including the desired fading to be employed.

The delayed optical signals are then combined at the dual-entry High-Speed Photodetectors (HSPD) that utilize photodetectors 124, resulting in a photocurrent influenced by the optical fading effect, which aids in reducing out-of-band interference. This photocurrent is subsequently converted into an electrical signal by the transimpedance amplifiers, TIA XI and TIA XQ 126. TIA XI 126 processes the in-phase component, while TIA XQ processes the quadrature component. These amplifiers can be important for converting the optical signal into a format that can be further processed by digital signal processing components. Overall, the circuit 100 illustrates components that perform the function or methodology of processing the Sig X 104 using optical fading techniques to enhance signal quality and reduce interference in high-speed optical communication systems. In one embodiment, one or more of the components described herein can be provided, arranged and/or configured as described herein and the TIA(s) can then be provided which further facilitates the electric photocurrent being converted into an electrical voltage signal.

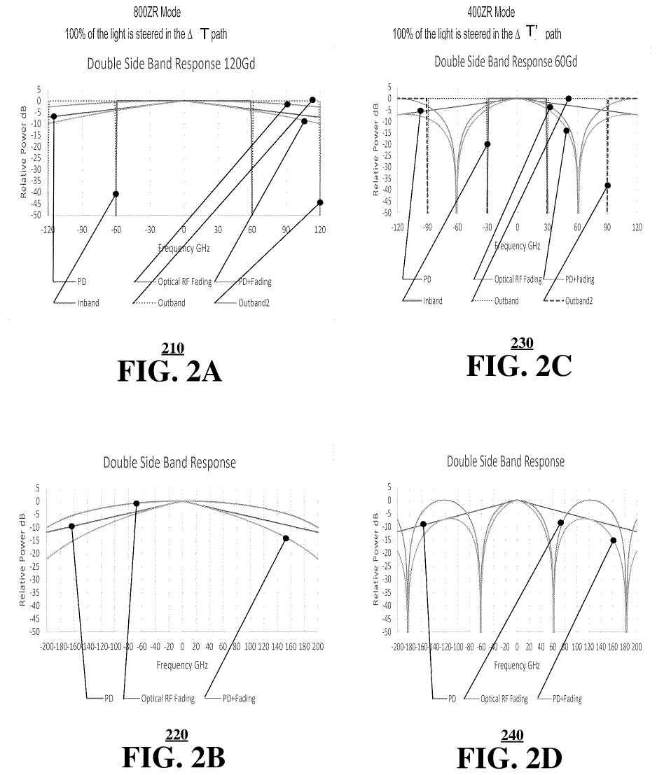

FIGS. 2A-2D are block diagrams illustrating exemplary, non-limiting embodiments of relative power results 210, 220, 230, 240 in accordance with various aspects described herein utilizing circuit 100. FIGS. 2A and 2C illustrate double side band response for 800ZR and 400ZR, respectively. Dashed lines are adjacent channels in a colorless system which are intended to be rejected. Lines are shown illustrating photodetector response, fading response, the sum of the response of the fading and photodetector, inband and outband(s). FIGS. 2B and 2D illustrate double side band response for 800ZR and 400ZR, respectively, showing only photodetector and fading responses. Fading can be important to minimizing the adjacent channel's generated photocurrent, not only in an AC sense but also DC which contributes to shot noise and DC loading of the front end of the TIA.

FIG. 3 is a block diagram illustrating an exemplary, non-limiting embodiment of a circuit 300 in accordance with various aspects described herein illustrating single polarization in an ICR with tunable fading. Circuit 300 shows an example of variable fading where in the secondary path an additional TPS is added to vary the amount of light between the ΔT and ΔT′ paths. Other lengths of paths and thus other delays in picoseconds can be utilized depending on a number of factors including the desired fading to be employed.

Circuit 300 provides backwards compatibility for optical components via a variable fading tuner, which in some embodiments can build on a fading function after the hybrid mixer. For instance, a 2×2 MMI based 50/50 splitter can be utilized to split the light equally between one direct path to one side of a dual-entry HSPD and a second path to a 2×2 MMI MZM with a TPS phase controller, followed by mismatched optical paths and also followed by a second 2×2 MMI MZM to steer all the light into other side of the dual-entry HSPD.

Thermal Phase Shifters (TPSs) can be used to switch light between the Δ2 ps and Δ10 ps paths, based off the Rx operating mode: for example for 800ZR all the light is steered in the Δ2 ps, while in 400ZR all the light is tuned to the Δ10 ps path. Multiple TPSs can be utilized including adding a third TPS as illustrated in FIG. 3.

If necessary or desired, the reference path sent to the other entry port of the photodiode with no tuning may be matched in waveguide dispersion to support the band of interest. This may include changing the waveguide type, width, or any relevant property to match components realizing the tuning in the other path, such as MMI couplers and TPS. For example, a 1-to-1 MMI may match the 2×2 MMI in dispersion characteristics.

In one or more embodiments, a DSP can have BB and LB power detectors, such as covering 0 to FS/2 and lower from 0 to FS/4, where the upper band power is BB-LB.

In 400ZR mode, the modem's digital power detectors can be used to control the TPS to maximize or improve the signal in the lower band and minimize the power in the upper band. In 800ZR mode, the modem's digital power detector can be used to control the TPS to maximize or improve the signal throughout the whole band.

In one embodiment, a TPS tunes the amount of light between the Δ2 ps and Δ10 ps paths, based off the Rx operating mode, such as for example where in 800ZR all the light is steered in the Δ2 ps path, and in 400ZR most of the light can be tuned to the Δ10 ps path.

In circuit 300, the processing of the Sig X 304 is illustrated within an ICR system. The incoming optical signal “Sig X” 304 can be combined with the LO signal 302 in a 90° hybrid mixer 306. This hybrid mixer 306 splits the signal into in-phase (I) and quadrature (Q) components, which are labeled as XIp 308, XIn 310, XQn 312, and XQn 314. Each of these component signals can be processed through a series of 2×2 MMIs 316 and TPSs 318. The MMIs 316 split the light into two paths, allowing for the introduction of optical delays. The TPSs 318 are used to control the phase of the light in one of the paths, enabling selectable and variable optical fading. For example, the light can be directed through delay paths of different lengths, such as 2 picoseconds path 320 and 10 picoseconds path 322. These delays are used to create a fading effect that helps filter out unwanted signals and improve the SNR. The delayed optical signals are then combined at dual-entry HSPDs 324, resulting in a photocurrent influenced by the optical fading effect, which aids in reducing out-of-band interference.

This photocurrent is subsequently converted into an electrical signal by the transimpedance amplifiers, TIA XI and TIA XQ 326. TIA XI 326 processes the in-phase component, while TIA XQ processes the quadrature component. These amplifiers are important for converting the optical signal into a format that can be further processed by digital signal processing components. Overall, circuit 300 performs a method of processing the “Sig X” component using optical fading techniques to enhance signal quality and reduce interference in high-speed optical communication systems.

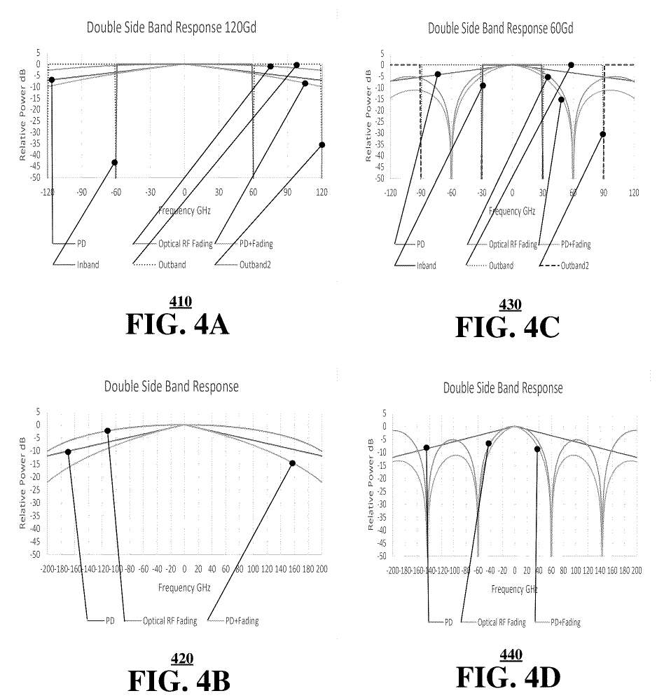

FIGS. 4A-4D are block diagrams illustrating exemplary, non-limiting embodiments of relative power results 410, 420, 430, 440 in accordance with various aspects described herein utilizing circuit 300. FIGS. 4A and 4C illustrate double side band response for 800ZR and 400ZR, respectively. Dashed lines are adjacent channels in a colorless system which are intended to be rejected. Lines are shown illustrating photodetector response, fading response, the sum of the response of the fading and photodetector, in-band and out-band(s). FIGS. 4B and 4D illustrate double side band response for 800ZR and 400ZR, respectively, showing only photodetector and fading responses. Fading can be important to minimizing the adjacent channel's generated photocurrent, not only in an AC sense but also DC which contributes to shot noise and DC loading of the front end of the TIA.

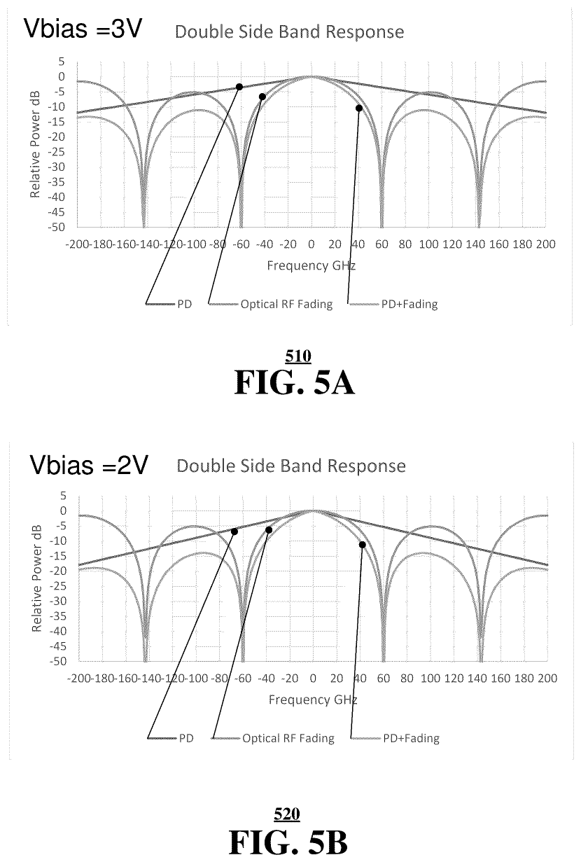

FIGS. 5A-5B are block diagrams illustrating exemplary, non-limiting embodiments of relative power results 510, 520 in accordance with various aspects described herein utilizing circuit 100. FIGS. 5A and 5B illustrate double side band response for 800ZR with a 3V bias across the HSPD and double side band response for 400ZR with a 2V bias or less across the HSPD, respectively. Lines are shown illustrating photodetector response, fading response, and the sum of the response of the fading and photodetector. This can be performed using 8 TPS controls from an HC-DAC.

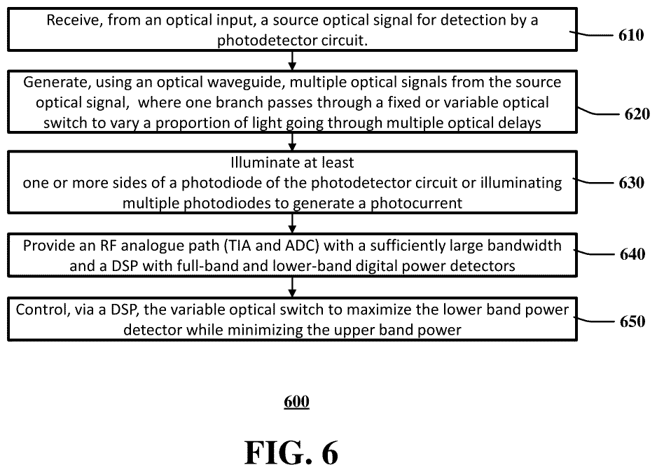

FIG. 6 depicts an illustrative embodiment of a method 600 in accordance with various aspects described herein. The method 600 provides for processing of an optical signal such as within a photodetector circuit. A source optical signal can be received from an optical input for detection by the photodetector circuit at 610. This can involve capturing the incoming optical signal that carries data to be processed. Multiple optical signals can be generated from the source optical signal using an optical waveguide at 620. For example, the optical waveguide can split the source signal into multiple paths. In one embodiment, one of these paths passes through a fixed or variable optical switch, which varies the proportion of light going through multiple optical delays. This step can be important for creating the necessary conditions for optical fading, which facilitates filtering out unwanted signals. At 630, at least one or more sides of a photodiode within the photodetector circuit can be illuminated or multiple photodiodes can be illuminated to generate a photocurrent. This illumination can be used for converting the optical signals into an electrical current, which can then be processed further.

At 640, the method 600 provides an RF analogue path, including a TIA and an analog-to-digital converter (ADC), with a sufficiently large bandwidth. A DSP with full-band and lower-band digital power detectors can be employed. This setup ensures that the system can handle a wide range of frequencies and accurately process the incoming signals. At 650, the method 600 involves controlling the variable optical switch via the DSP to maximize or minimize power bands, such as maximizing the in-band power while minimizing out band power. This control step can be important for optimizing or improving the SNR by focusing on the desired signal frequencies and reducing interference from unwanted frequencies. Various other control schemes can be implements including maximizing and minimizing of select power bands in order to improve SNR and improve operations of the system.

Overall, method 600 describes a comprehensive approach to processing an optical signal, utilizing optical and electrical components to enhance signal quality and reduce interference in high-speed optical communication systems. While for purposes of simplicity of explanation, the respective processes are shown and described as a series of blocks in FIG. 6, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

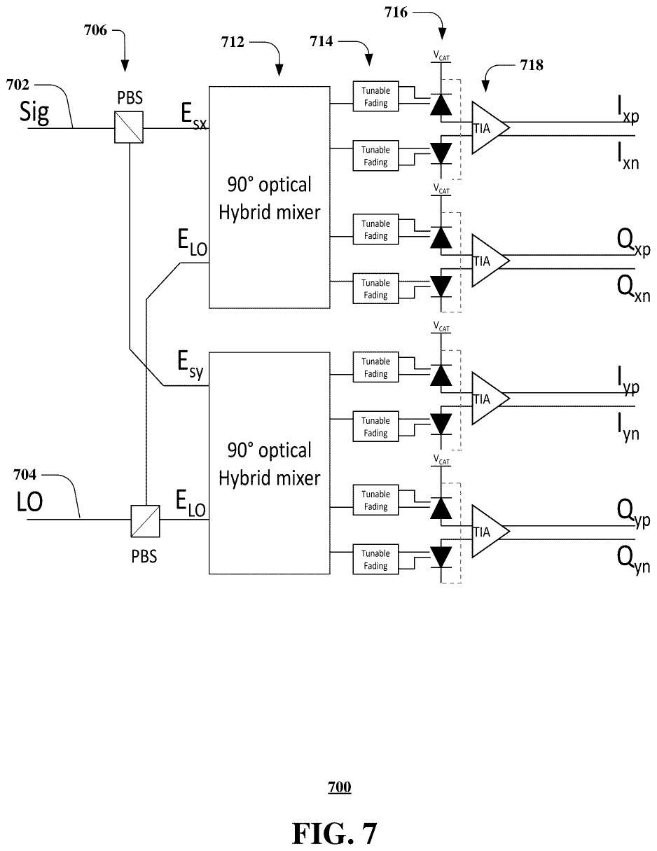

FIG. 7 is a block diagram illustrating an exemplary, non-limiting embodiment of a circuit 700 in accordance with various aspects described herein. FIG. 7 illustrates an ICR block diagram with tunable fading and includes options for either dual entry PDs or dual PDs for improved LO leakage. In one or more embodiments, the embodiments described in reference to FIGS. 1 and 3 are used in whole or in part to implement the optical front end of the ICR 700. In particular, the inputs of the ICR 700 are denoted as Sig (signal) and LO (local oscillator), while the outputs are denoted as Ixp, Ixn, Qxp, Qxn, Iyp, Iyn, Qyp and Qyn. The split function and optical delay to achieve the RF fading is introduced between the hybrid mixers 712 and the photodetectors 712 within the ICR 700 and optical path lengths between the components. The output amplifiers 718 are denoted as TIA (trans-impedance amplifier) that convert the photocurrents of the photodetectors 716) into electrical output signals. With no RF fading, the input transistor of the TIA is virtually receiving the same amount of neighboring out-of-band channel power as the in-band channel. As a result, the TIA front end may become overloaded, or may have to be overdesigned leading to tradeoffs in thermal noise performance. The optical method to induce the RF fading described above mitigates the over-saturation and resultant effects.

In FIG. 7, the circuit 700 processes the input optical signal “SIG” 702 within an ICR system. The input optical signal 702 is first directed into a Polarization Beam Splitter (PBS) 706, which separates the signal into its orthogonal polarization components, Eₛₓ 708 and E_{sy}. These polarization components are then fed into two separate 90° optical hybrid mixers 712. The first hybrid mixer 712 processes the Eₛₓ component, while the second hybrid mixer processes the E_{sy} component. Each hybrid mixer 712 also receives a local oscillator (LO) signal 704, which is similarly split by a PBS 706 into its polarization components, Eₗₒ.

Within each 90° optical hybrid mixer 712, the incoming signal 702 and LO components 794 are combined to produce in-phase (I) and quadrature (Q) components. These components are important for coherent detection, allowing the extraction of both amplitude and phase information from the optical signal.

The outputs from the hybrid mixers 712 are then directed to tunable fading circuits or modules 714. These modules 714 can introduce selectable and variable optical delays to the signal paths, enabling the system to perform optical fading. This process helps filter out unwanted signals and improve the SNR. As an example, one or more features of circuit 100 and/or circuit 300 can be used in each of the modules 714 for providing selectable or tunable optical fading as described herein.

The faded optical signals are then detected by high-speed photodetectors 716, which convert the optical signals into photocurrents. These photocurrents are subsequently amplified by TIAs 718. The TIAs convert the photocurrents into electrical signals, which are labeled as Iₓₚ, Iₓₙ, Qₓₚ, Qₓₙ, I_{yp}, I_{yn}, Q_{yp}, and Q_{yn}. These signals represent the complementary in-phase and quadrature components for both polarizations of the input signal.

Overall, circuit 700 illustrates a device for processing the input optical signal using optical fading techniques to enhance signal quality and reduce interference in high-speed optical communication systems.

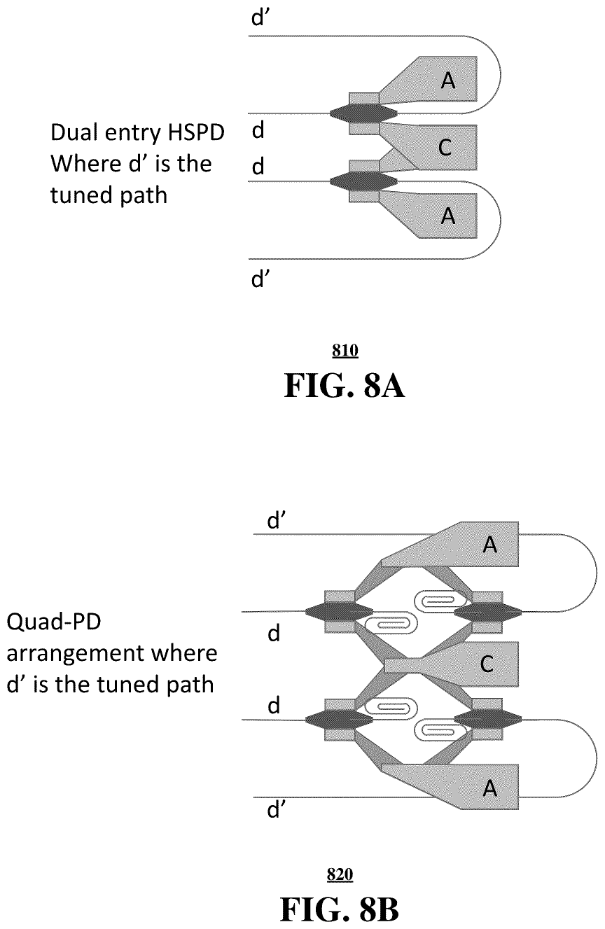

FIGS. 8A-8B are block diagrams illustrating exemplary, non-limiting embodiments of circuits 810, 820 in accordance with various aspects described herein. A dual-entry HSPD 810 operates by utilizing two separate optical inputs to enhance the detection and processing of optical signals. This configuration is particularly beneficial in coherent optical communication systems. The dual-entry HSPD 810 receives optical signals from two distinct paths that can be created by splitting the incoming optical signal using components like MMIs and directing the light through different delay paths. This configuration allows the photodetector to process signals that have been phase-shifted or delayed differently, which is important for implementing optical fading. The two optical signals entering the dual-entry HSPD 810 can be combined within the photodetector. This combination results in a photocurrent that is influenced by the relative phase and amplitude of the incoming signals. For example, by controlling the phase and delay of the signals, the system can create a fading effect that helps filter out unwanted frequencies and improve the SNR. The combined optical signals generate a photocurrent within the photodetector. This photocurrent is a result of the photoelectric effect, where the energy from the light is converted into an electrical current. The dual-entry configuration allows for more complex signal processing, as it can leverage the interference patterns created by the two optical paths. The generated photocurrent is then processed by TIAs, which convert the current into a voltage signal that can be further processed by digital signal processing components. The dual-entry configuration facilitates in reducing out-of-band interference and enhancing the overall performance of the receiver. Overall, the dual-entry HSPD 810 (and the HSPD 820 described herein) can be an important component in advanced optical communication systems, enabling sophisticated signal processing techniques like optical fading to improve data transmission quality and efficiency.

A quad-entry HSPD 820 operates by utilizing four separate optical inputs to enhance the detection and processing of optical signals. This configuration is particularly beneficial in coherent optical communication systems. The quad-entry HSPD 820 receives optical signals from four distinct paths. These paths can be created by splitting the incoming optical signal using components like MMIs and directing the light through different delay paths. This configuration allows the photodetector to process signals that have been phase-shifted or delayed differently, which is important for implementing optical fading.

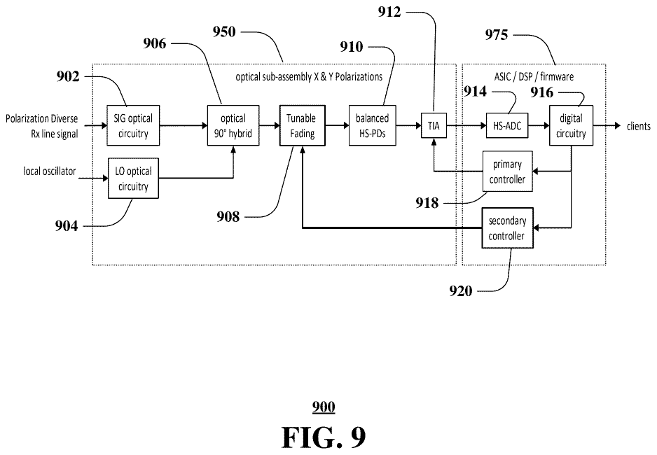

FIG. 9 is a block diagram illustrating an exemplary, non-limiting embodiment of a device or circuit 900 in accordance with various aspects described herein. Device 900 illustrates features that include a secondary fading controller connecting to the DSP's digital circuitry and primary and secondary control loops. The secondary controller then drives the tuning element in the fading arm (e.g., thermal phase shifter(s) driven by a high-current DAC). In one embodiment, this secondary controller may only engage when a supervisory circuit (e.g., in hardware and/or firmware) determines that the primary loop is in steady-state so that the fading does not erroneously detune due to optical transients from the line; this supervisory circuit can monitor the primary control signals for steady-state behavior and may monitor other locations of the respective primary control loops and/or DSP for signal integrity. As an example, the supervisory circuit can also dither the TPS signal or read receiver DSP-calculated spectral tilt to detect slope. In one embodiment, the underlying controller can be any kind of PID, LQR, or similar controller that drives to a target, or may be a fixed pre-calibrated value, and may be implemented in the digital and/or analog domains. In one embodiment, the starting TPS drive level can be calibrated during manufacturing or stored from previous optimal operation to seed the controller at modem start-up. In one embodiment, before the secondary loop starts, it can store the present value of the HC-DAC in case the primary loop suddenly jumps due to a transient event on the line; in this case the secondary loop halts and writes that stored value back to the HC-DAC so that the secondary loop cannot become confused or cannot mis-set the optical fading.

Device 900 provides primary and secondary control loop interconnect architecture (one of two optical polarizations shown and one of either the in-phase or Quadrature components). The primary control loop of each receiver regulates the HS-ADC input voltage by measuring digital power and driving a low-side (LS) DAC into the TIA gain control circuits. The secondary fading controller optimizes or improves the filtering by controlling the TPS and monitoring the Full-Band and Lower-Band control signals coming from the digital circuitry. While not illustrated, the architecture can be duplicated for a second optical polarization within the modem or device.

In FIG. 9, the circuit 900 processes an incoming polarization diverse Rx line signal using a series of components designed for coherent optical communication. The signal enters through the SIG optical circuitry 902, while the local oscillator (LO) signal is provided by the LO optical circuitry 904. These signals are combined in the optical 90° hybrid mixer 906, which splits the incoming signal into in-phase (I) and quadrature (Q) components, which is important for extracting both amplitude and phase information.

The outputs from the optical 90° hybrid mixer 906 are fed into the tunable fading module 908 (which can be in whole or in part circuit 100 and/or 300). This module 908 introduces selectable, tunable and/or variable optical delays to the signal paths, enabling the system to perform optical fading. This process helps filter out unwanted signals and improve the SNR. The faded optical signals are detected by balanced High-Speed Photodetectors (HS-PDs) 910, which convert the optical signals into photocurrents. The balanced configuration helps in reducing common-mode noise and improving the overall performance of the receiver.

The photocurrents generated by the HS-PDs 910 are converted into electrical signals by the transimpedance amplifier (TIA) 912. The TIA 912 can be important for amplifying the weak photocurrents into a format suitable for further processing. These amplified signals are then digitized by the High-Speed Analog-to-Digital Converter (HS-ADC) 914, which converts the analog signals into digital form for processing by digital circuitry 916.

The digital circuitry 916 processes the digitized signals, and the primary and secondary controllers 918, 920 manage the overall operation of the system. As an example, the primary controller 918 can regulate the HS-ADC input voltage, while the secondary controller 920 optimizes or improves the filtering by controlling the tunable fading elements. Overall, the circuit 900 in FIG. 9 illustrates a sophisticated method of processing an incoming polarization diverse Rx line signal using optical fading techniques to enhance signal quality and reduce interference in high-speed optical communication systems through use of the various components of the sub-assembly 950 and controller assembly 975.

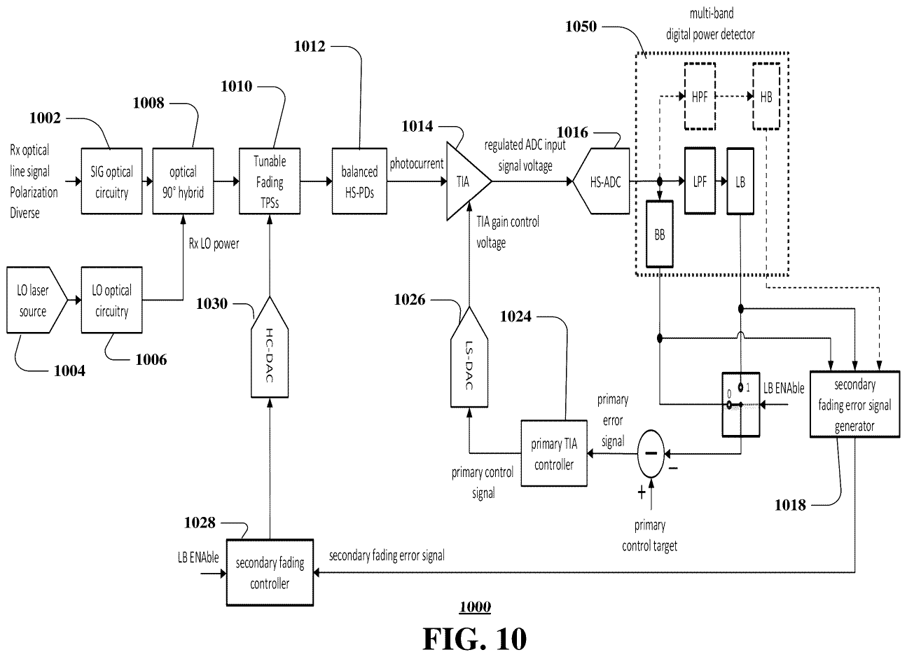

FIG. 10 is a block diagram illustrating an exemplary, non-limiting embodiment of a device or circuit 1000 in accordance with various aspects described herein. It should be understood that circuit 1000 or portions thereof (e.g., components downstream of the optical hybrid mixer 1008) can be replicated (e.g., 4 times) for IQ and XY. FIG. 10 shows primary and secondary loop architectures: the secondary controller reads the LB and BB power and depending on the mode either maximizes the BB power for full-Baud or in the case of half-Baud minimizes the BB−LB power while maximizing LB-Power. In one embodiment, BB−LB power could be replaced by a high-pass power detector representing the high-band (HB) FS/4 to FS/2, so in the half-Baud one would minimize HB power while maximizing LB-Power.

Device 1000 includes fading controller architecture. This secondary control loop, depending on operation mode (e.g., mode Full-Baud or Half-Baud) either maximizes the Broadband power detector control signals or the lower-baud power detector, respectively. Device 1000 allows a dual-polarization optical line signal to enter the modem's receiver (Rx), where it is processed by signal (SIG) optical circuitry and subsequently mixed with a local oscillator (LO, from a laser source within the modem) in an optical 90° hybrid; (beyond the SIG optical circuitry this entire configuration can be duplicated for a second polarization) and (beyond the optical hybrid mixer this configuration can be duplicated for a second carrier phase or tributary). The mixed signal then proceeds through the tunable optical fading circuits described elsewhere herein, then is converted to photocurrent by high-speed photodetectors (HS-PDs). A variable gain transimpedance amplifier (TIA) regulates the signal voltage into the high-speed ADC to optimize Rx SNR. HS-ADC samples pass into a broadband power detector (BB), and through a low-pass filter (LPF) into a low-band power detector (LB), and optionally through a high-pass filter (HPF) into an optional high-band power detector. Each power detector may perform RMS calculation, accumulation, down-sampling, and/or appropriate scaling and offsetting for subsequent steps. The BB and LB signals enter a switch (or more sophisticated mixer which is not shown) to drive a primary control loop to regulate HS-ADC input voltage consisting of a primary error signal function with a primary control target value (computed and/or calibrated), a primary TIA controller (PID or similar, with appropriate scaling and target offsets) that minimizes the primary error signal by driving a low-speed DAC (LS-DAC) that controls the TIA's gain. In one embodiment for device 1000, when the modem is in broadband mode, the BB power detector signal is used, and when the modem is in low-band mode, the LB power detector signal or an appropriate mix of BB and LB signals is used. In one embodiment, BB, LB, and/or HB power detector signals can also enter a secondary fading error signal generator, that generates a secondary fading error signal to be minimized by a secondary fading controller that drives the tunable optical fading circuits through a high-current DAC (HC-DAC).

In FIG. 10, the circuit 1000 processes an incoming polarization diverse Rx optical line signal using a series of components designed for coherent optical communication. The signal first enters the SIG optical circuitry 1002, where it is prepared for further processing. Simultaneously or otherwise, the local oscillator (LO) signal is generated by the LO laser source 1004 and processed through the LO optical circuitry 1006. These two signals are then combined in the optical 90° hybrid mixer 1008, which splits the incoming signal into in-phase (I) and quadrature (Q) components, essential for extracting both amplitude and phase information.

The outputs from the optical 90° hybrid mixer 1008 are fed into the tunable fading module 1010, which includes Thermal Phase Shifters (TPSs) and which can include in whole or in part components of circuits 100 and/or 300. This module 1010 introduces selectable, tunable and/or variable optical delays to the signal paths, enabling the system to perform optical fading. This process helps filter out unwanted signals and improve the SNR. The faded optical signals are detected by balanced High-Speed Photodetectors (HS-PDs) 1012, which convert the optical signals into photocurrents. The balanced configuration helps in reducing common-mode noise and improving the overall performance of the receiver.

The photocurrents generated by the HS-PDs 1012 are converted into electrical signals by the TIA 1014. The TIA 1014 can be important for amplifying the weak photocurrents into a format suitable for further processing. These amplified signals are then digitized by the High-Side Analog-to-Digital Converter (HS-ADC) 1016, which converts the analog signals into digital form for processing by digital circuitry.

The digital circuitry can include a multi-band digital power detector 1050, which analyzes the digitized signals across different frequency bands and using various filters, such as: Broad-Band (BB), LowBand (LB), HighBand (HB), Low-Pass Filter (LPF), and High-Pass Filter (HPF). The primary control loop, consisting of the primary error signal from the primary TIA controller 1024, regulates the Low-Side Digital-to-Analog Converter (LS-DAC) 1026 in providing the TIA gain control voltage to the TIA 1014 for obtaining a particular regulated ADC input signal voltage that is passed to the HS-ADC 1016. This loop ensures that the signal is maintained at an optimal level for accurate processing. Oversampling enables a BB operation with Half-Baud to observe a neighboring channels power (i.e., aggressor) to tune out with the fading. Over-sampling at an ADC can allow for implementation of a ‘brick-wall’ like or Root Raised Cosine (RRC) type filter for the half baud mode while still allowing the use of a BB-detector to observe an out-of-band power from a neighboring channel to minimize the difference between the BB and LB, while maximizing the LB (Half-Baud). While over-sampling at the ADC can achieve filtering at the ADC, the neighboring channels power may still hit the front end of the TIA and if not sufficiently filtered, resultantly raising the noise floor of the TIA, from both thermal and frequency mixing, which still appear in the LB. As an example, 1.5 to 2× over-sampling may be performed at the ADC to facilitate or enable dual-band power detector.

Additionally, the secondary fading controller 1028, along with the secondary fading error signal generator 1018, manages the tunable fading elements by controlling the High-Current Digital-to-Analog Converter (HC-DAC) 1030 that feeds into the tunable fading module 1010. This secondary control loop optimizes or improves the filtering by adjusting the optical fading settings based on the detected power levels in the different frequency bands.

Overall, the circuit 1000 in FIG. 10 illustrates a sophisticated method of processing an incoming polarization diverse Rx optical line signal using optical fading techniques to enhance signal quality and reduce interference in high-speed optical communication systems.

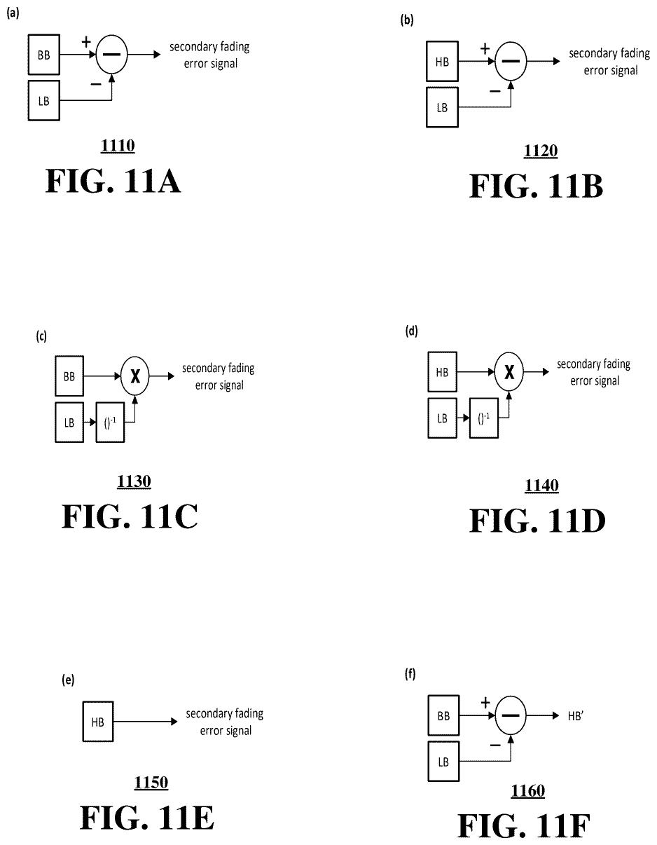

FIGS. 11A-11F are block diagrams illustrating exemplary, non-limiting embodiments of circuits 1110, 1120, 1130, 1140, 1150, 1160 in accordance with various aspects described herein. FIG. 11 illustrates possible configurations to derive a suitable error signal so that the secondary controller (e.g., controllers 920, 1028) minimizes the power in the spectrum above the low-baud signal. The error signal is to be minimized by the secondary fading controller by driving the selectable/tunable optical fading circuits described herein, and in each case the error can be proportional to the power outside the desired lower baud signal's spectrum. In circuit 1110, subtraction of the low-band power detector signal (LB) from the broadband power detector signal (BB), BB−LB is illustrated. In circuit 1120, subtraction of the LB signal from the high-band power detector signal (HB), HB-LB is illustrated. In circuit 1130, use of the ratio of the BB and LB signals, BB/LB is illustrated. In circuit 1140, use of a division of the HB and LB signals, HB/LB is illustrated. In circuit 1150, use of the HB signal directly is illustrated. In circuit 1160, a fabrication of a pseudo-HB signal HB′ from BB and LB signals if a proper HB signal is unavailable from the multiband power detector is illustrated.

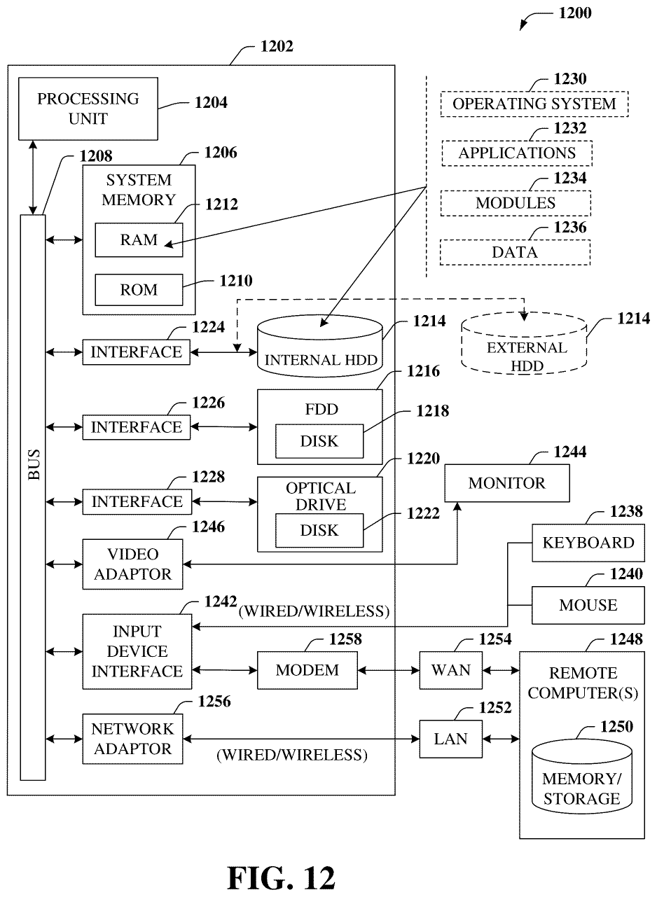

Turning now to FIG. 12, there is illustrated a block diagram of a computing environment 1200 in accordance with various aspects described herein. In order to provide additional context for various embodiments of the embodiments described herein, FIG. 12 and the following discussion are intended to provide a brief, general description of a suitable computing environment 1200 in which the various embodiments of the subject disclosure can be implemented. For example, computing environment 1200 can facilitate in whole or in part providing tunable optical fading, which can be achieved such as through use of MZIs and at least two additional delay paths, where dual entry, quad entry, or multiple HSPDs receive the total light to reduce peak intensity to mitigate charge screening effects. Environment 1200 can exist in various networks, systems, buildings, or other locations, including in a datacenter interconnect or metro regional optical network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 12, the example environment can comprise a computer 1202, the computer 1202 comprising a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multiprocessor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 comprises ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also comprise a high-speed RAM such as static RAM for caching data.

The computer 1202 further comprises an internal hard disk drive (HDD) 1214 (e.g., EIDE, SATA), which internal HDD 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high-capacity optical media such as the DVD). The HDD 1214, magnetic FDD 1216 and optical disk drive 1220 can be connected to the system bus 1208 by a hard disk drive interface 1224, a magnetic disk drive interface 1226 and an optical drive interface 1228, respectively. The hard disk drive interface 1224 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1212, comprising an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) can comprise a microphone, an infrared (IR) remote control, a joystick, a game pad, a stylus pen, touch screen or the like. These and other input devices are often connected to the processing unit 1204 through an input device interface 1242 that can be coupled to the system bus 1208, but can be connected by other interfaces, such as a parallel port, an IEEE 1394 serial port, a game port, a universal serial bus (USB) port, an IR interface, etc.

A monitor 1244 or other type of display device can be also connected to the system bus 1208 via an interface, such as a video adapter 1246. It will also be appreciated that in alternative embodiments, a monitor 1244 can also be any display device (e.g., another computer having a display, a smart phone, a tablet computer, etc.) for receiving display information associated with computer 1202 via any communication means, including via the Internet and cloud-based networks. In addition to the monitor 1244, a computer typically comprises other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically comprises many or all of the elements described relative to the computer 1202, although, for purposes of brevity, only a remote memory/storage device 1250 is illustrated. The logical connections depicted comprise wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the LAN 1252 through a wired and/or wireless communication network interface or adapter 1256. The adapter 1256 can facilitate wired or wireless communication to the LAN 1252, which can also comprise a wireless AP disposed thereon for communicating with the adapter 1256.

When used in a WAN networking environment, the computer 1202 can comprise a modem 1258 or can be connected to a communications server on the WAN 1254 or has other means for establishing communications over the WAN 1254, such as by way of the Internet. The modem 1258, which can be internal or external and a wired or wireless device, can be connected to the system bus 1208 via the input device interface 1242. In a networked environment, program modules depicted relative to the computer 1202 or portions thereof, can be stored in the remote memory/storage device 1250. It will be appreciated that the network connections shown are example and other means of establishing a communications link between the computers can be used.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
receiving an optical signal;
splitting the optical signal into multiple paths including a direct path, a first delay path, and a second delay path, wherein the splitting includes directing a first portion of the optical signal through the direct path to a photodetector, wherein the splitting includes selectively directing a second portion of the optical signal through the first and second delay paths of different lengths to introduce selectable and variable optical delays;
directing the second portion of the optical signal from the first and second delay paths to the photodetector; and
generating a photocurrent from the first portion and second portion of the optical signal at the photodetector.

2. The method of claim 1, wherein the selectively directing the second portion of the optical signal through the first and second delay paths includes directing the second portion of the optical signal through a Mach-Zehnder Interferometer (MZI) with a phase shifter.

3. The method of claim 2, wherein the phase shifter is at least two phase shifters, and wherein the at least two phase shifters include thermal phase shifters, carrier injection phase shifter, electro-optical phase shifters, or a combination thereof.

4. The method of claim 2, comprising controlling the phase shifter to maximize in-band power while minimizing out-of-band power.

5. The method of claim 1, wherein the directing of the second portion of the optical signal from the first and second delay paths comprises combining of delayed optical signals.

6. The method of claim 2, wherein the selectively directing of the second portion of the optical signal through the first and second delay paths of different lengths to introduce the selectable and variable optical delays includes the phase shifter steering the second portion of the optical signal based on an operating mode.

7. The method of claim 1, wherein the splitting of the optical signal into the multiple paths is by a splitter including a coupler, a directional coupler, a Y-branch, a Multi-Mode Interferometer (MMI), or a combination thereof.

8. The method of claim 1, further comprising processing the photocurrent with a transimpedance amplifier (TIA) to convert the electric photocurrent into an electrical voltage signal.

9. The method of claim 1, wherein the photodetector is a dual-entry photodetector, and wherein the directing the first portion of the optical signal through the direct path is to a first side of the dual-entry photodetector, and wherein the directing the second portion of the optical signal through the first and second delay paths is to a second side of the dual-entry photodetector.

10. The method of claim 1, wherein the photodetector includes a first photodiode and a second photodiode, wherein the directing the first portion of the optical signal through the direct path is to the first photodiode, and wherein the directing the second portion of the optical signal through the first and second delay paths is to the second photodiode.

11. The method of claim 1, comprising utilizing a Digital Signal Processor (DSP) to measure dual-band power.

12. The method of claim 8, wherein the TIA includes a variable gain control to adapt to different signal strengths.

13. The method of claim 1, comprising:
determining Lower Band (LB) and Broad Band (BB) power;
determining an operating mode; and
according the operating mode, either maximizing the BB power for full-Baud mode or minimizing a difference between the BB and LB power while maximizing the LB Power for half-baud mode.

14. A circuit, comprising:
a 90° hybrid mixer configured to receive a local oscillator (LO) signal and an optical signal, the 90° hybrid mixer splitting the incoming optical signal into in-phase (I) and quadrature (Q) components; and
for each output of the 90° hybrid mixer:
a splitter coupled to the output of the 90° hybrid mixer, the splitter configured to steer a portion of light from the output of the 90° hybrid mixer between a plurality of delay paths of different lengths to create a selectable and variable optical fading effect; and
a photodetector configured to generate an electric photocurrent influenced by the optical fading effect.

15. The circuit of claim 14, wherein the plurality of delay paths includes a first delay path of 0.05 to 10 picoseconds and a second delay path of 0.5 to 100 picoseconds.

16. The circuit of claim 14, wherein the splitter includes a coupler, a directional coupler, a Y-branch, a Multi-Mode Interferometer (MMI), or a combination thereof.

17. The circuit of claim 14, wherein the photodetector comprises a dual-entry photodetector or multiple photodiodes.

18. A method performed in a coherent modem, the method comprising:
determining an operating mode of the coherent modem;
receiving an optical signal at an Intradyne Coherent Receiver (ICR);
splitting the optical signal into a plurality of components including in-phase (I) and quadrature (Q) components;
performing tunable optical fading on the plurality of components of the optical signal based on the operating mode;
generating an electrical photocurrent influenced by the tunable optical fading at a photodiode; and
converting the electrical photocurrent to an electrical voltage signal at a transimpedance amplifier (TIA).

19. The method of claim 18, wherein the operating mode is a full-Baud mode or a half-baud mode.

20. The method of claim 19, further comprising:
determining Lower Band (LB) and Broad Band (BB) power from the electrical voltage signal; and
according to the operating mode either maximizing the BB power for the full-Baud mode or minimizing a difference of the BB and LB powers while maximizing LB-Power for the half-baud mode.
